(19) United States
(12) Patent Application Publication
(10) Pub. No.: US 2024/0219900 A1
(43) Pub. Date: Jul. 4, 2024

(54) NONLINEAR SPARSITY-BASED INSTANTANEOUS DYNAMIC FREQUENCY FAULT DIAGNOSIS METHOD FOR AVIATION INTERMEDIATE BEARING

(71) Applicant: XI'AN JIAOTONG UNIVERSITY, Xi'an (CN)

(72) Inventors: Shibin WANG, Xi'an (CN); Yiming ZHENG, Xi'an (CN); Chuanyi CHENG, Xi'an (CN); Baoqing DING, Xi'an (CN); Zhibin ZHAO, Xi'an (CN); Xuefeng CHEN, Xi'an (CN)

(21) Appl. No.: 18/543,433

(22) Filed: Dec. 18, 2023

(30) Foreign Application Priority Data
Dec. 27, 2022 (CN) 2022117416076

(51) Int. Cl. G05B 23/02; G01M 13/045

(52) U.S. Cl. CPC G05B 23/0281; G01M 13/045; G05B 23/024

(57) ABSTRACT

The present disclosure discloses a nonlinear sparsity-based instantaneous dynamic frequency fault diagnosis method for an aviation intermediate bearing. In the method, a vibration signal and a rotating speed signal of high and low voltages of the intermediate bearing are acquired, and a vibration signal fragment x under a specific working condition is intercepted according to the rotating speed signal; a nonlinear sparse time-frequency enhancement model or a nonlinear sparse enhancement algorithm model is established based on derivative window function short-time Fourier transform of the vibration signal; the nonlinear sparse time-frequency enhancement model is solved or the nonlinear sparse enhancement algorithm model is improved by using a fast iterative shrinkage threshold algorithm and combining a k sparse strategy, and finally a nonlinear sparse time-frequency representation result \hat{N}ₓ, may be obtained through iterative optimization.

### CROSS-REFERENCE TO RELATED APPLICATION

This application claims priority from the Chinese patent application 2022117416076 filed Dec. 27, 2022, the content of which is incorporated herein in the entirety by reference.

### TECHNICAL FIELD

The present disclosure belongs to the technical field of fault diagnosis for rotating machinery, and particularly discloses a nonlinear sparsity-based instantaneous dynamic frequency fault diagnosis method for an aviation intermediate bearing.

### BACKGROUND

Intermediate bearings are commonly used in dual rotor structures of aeroengines and are key components supporting high and low voltage rotors. Different from ordinary main bearings, the intermediate bearings are inter-shaft bearings, with inner and outer rings connected to low-voltage rotors and high-voltage rotors of engines respectively, and therefore, they rotate at a high speed simultaneously and in opposite directions. Due to the above working principles and structural characteristics, the intermediate bearings of the engines are more prone to faults compared to other main bearings. A traditional bearing fault diagnosis method is to extract fault feature frequencies based on periodic impact features generated by faults. However, when using the traditional method to perform fault diagnosis on the intermediate bearings, the following problems may occur: firstly, a contact angle of an intermediate bearing is not a constant value and may change within a certain range, and therefore, even when a rotating speed of an engine is constant, a fixed fault feature frequency cannot be calculated; secondly, main bearings of the aeroengine all have large DN values, which may lead to a phenomenon of mixed fault impacts, in addition, the main bearing fault of the engine is often an overall fault problem, that is, more than one component such as an inner ring, an outer ring, a rolling body and a holder fails simultaneously, and this phenomenon may lead to complex fault features, which are difficult to represent by using the fault feature frequency of a single component; and finally, the intermediate bearing cannot be directly connected with an engine casing, vibration features need to pass through a series of complex paths to be transmitted to vibration test points, which may make it difficult to fully transmit the fault impact features, or the features are very weak. The above problems will make it difficult for the traditional bearing fault diagnosis method to play a role in fault diagnosis of the intermediate bearings. Therefore, it is necessary to study intermediate bearing fault diagnosis methods based on other fault features.

In addition, due to the complex transmission paths of vibration signals and strong background noise, the fault features in the acquired vibration signals may be weak, especially in an early stage of the faults, which is very unconducive to extracting the fault features. Therefore, strengthening the weak fault features in the vibration signals is crucial to the fault diagnosis of the intermediate bearings in the aeroengines. An amplitude of a spectrum and a time-frequency map obtained by a traditional spectral analysis and time-frequency analysis method is generally linearly correlated with a signal time-domain amplitude, and therefore, the weak features in a time domain are still weak when transformed into a frequency domain or time-frequency domain. When there are interference components with large amplitudes around, it is often difficult to effectively extract the weak fault features. Nonlinear compression transform can nonlinearly enhance feature components and weaken the correlation with the amplitude through a synergistic effect of matching between short-time Fourier transform and derivative window function short-time Fourier transform, so that the weak fault features have a better representation effect, which is conducive to feature extraction and fault diagnosis. However, since the nonlinear compression transform has a nonlinear enhancement effect on features of a whole time-frequency plane, noise components are also enhanced, and noise robustness of the method is reduced. Therefore, it is necessary to improve or propose a new algorithm to replace the original nonlinear compression transform, which not only nonlinearly enhances the weak fault feature components, but also has better noise robustness for fault diagnosis of the intermediate bearings in the aeroengines.

The above information disclosed in the background section is only used to enhance the understanding of the background of the present disclosure, and therefore, it may contain information that does not constitute the prior art known to those ordinarily skilled in the art.

### SUMMARY

Aiming at the problems existing in the prior art, the present disclosure provides a nonlinear sparsity-based instantaneous dynamic frequency fault diagnosis method for an aviation intermediate bearing. The method utilizes an instantaneous dynamic frequency characteristic of the intermediate bearing when a fault occurs, and based on a nonlinear sparse time-frequency enhancement method, a new intermediate bearing fault discrimination criterion is designed. The intermediate bearing is simultaneously connected to high and low voltage rotors of an engine, due to this support characteristic, a coupling phenomenon of high and low voltage rotating frequencies is prone to occurring when a fault occurs, that is, the high-voltage rotor rotating frequency supported on the low-voltage rotor may have a certain degree of fluctuation, which is referred to as an instantaneous dynamic frequency phenomenon. After experimental exploration, the instantaneous dynamic frequency phenomenon of the high-voltage rotor when the intermediate bearing fails is mainly manifested as: a time-frequency ridge near the high-voltage rotating frequency is modulated by the low-voltage rotating frequency, that is, a fast variable frequency modulation phenomenon with the high-voltage rotating frequency as a fundamental frequency and the low-voltage rotating frequency as a modulation frequency occurs. Compared to a traditional fault diagnosis method based on a fault feature frequency, the fault diagnosis method based on an instantaneous dynamic frequency provided by the present disclosure is based on the high and low voltage rotating frequencies in vibration signals, and is not limited by the difficulty in fully transmitting impact features to vibration test points, thus making it easier to judge the occurrence of intermediate bearing faults.

In addition, in the present disclosure, the fault features of the intermediate bearing, namely the instantaneous dynamic frequency phenomenon, are enhanced through the nonlinear sparse time-frequency enhancement method, the surrounding noise interference is reduced, so that feature extraction is promoted, and fault diagnosis is completed. The present disclosure provides the nonlinear sparse time-frequency enhancement method with two forms of model driving and algorithm driving, the method of model driving utilizes a ridge perception ability of derivative window function short-time Fourier transform and different distribution features of signal components and noise to establish a weak feature robust enhancement weighting matrix, and a sparse regular term is weighted, so as to preliminarily strengthen a time-frequency ridge and weaken noise distribution; and then, a synergistic effect of matching with the derivative window function short-time Fourier transform is utilized, and the ridge features of time-frequency distribution are nonlinearly enhanced, which is more conducive to extraction of weak feature components. Different from model driving, the nonlinear sparse time-frequency enhancement method with the form of algorithm driving is directly based on an iterative threshold shrinkage algorithm, considering that the time-frequency transform and an inverse transform result thereof in a gradient descent process are both positively correlated with a signal feature amplitude, a weak feature enhancement strategy of nonlinear compression transform is utilized, in a time-frequency transform and inverse transform operator, the weak feature robustness enhancement weighting matrix is introduced, so that the amplitude correlation is weakened, extraction of the weak feature components is enhanced, and noise distribution is weakened. The nonlinear sparse time-frequency enhancement method with the two forms is applied to an instantaneous dynamic frequency fault diagnosis flow of the intermediate bearing in the aeroengine, and robust extraction of the weak fault features may be effectively promoted, so that it is more conducive to completing fault diagnosis.

The objective of the present disclosure is implemented through the following technical solution, a nonlinear sparsity-based instantaneous dynamic frequency fault diagnosis method for an aviation intermediate bearing includes the following steps:
in a first step, acquiring a vibration signal and a rotating speed signal of the intermediate bearing, and intercepting a vibration signal fragment x∈ [symbol] under a specific working condition according to the rotating speed signal;
in a second step, performing derivative window function short-time Fourier transform Pₓ∈ [symbol] based on the vibration signal fragment x∈ [symbol] , constructing a denoising time-frequency matrix Qₓ∈ [symbol] based on the derivative window function short-time Fourier transform Pₓ∈ [symbol] , and obtaining a weighting matrix W∈ [symbol] by diagonalizing the denoising time-frequency matrix Qₓ∈ [symbol] ;
in a third step, establishing a nonlinear sparse time-frequency enhancement model or a nonlinear sparse enhancement algorithm model based on the weighting matrix W;
in a fourth step, solving the nonlinear sparse time-frequency enhancement model or improving the nonlinear sparse enhancement algorithm model by using a fast iterative shrinkage threshold algorithm and combining a k sparse strategy, and obtaining a nonlinear sparse time-frequency representation result \hat{N}ₓ∈ [symbol] through iterative optimization;
in a fifth step, extracting an instantaneous dynamic frequency ridge based on the nonlinear sparse time-frequency representation result \hat{N}ₓ, and obtaining a spectrum feature by performing spectrum analysis of a ridge oscillation part; and
in a sixth step, calculating a fault feature indicator of the intermediate bearing based on the instantaneous dynamic frequency ridge and the spectrum feature thereof, and comparing the fault feature indicator with a preset threshold to complete fault diagnosis.

In the method, in the first step, the vibration signal is acquired by a vibration acceleration sensor, vibration test points are arranged at other bearing support points closest to the intermediate bearing, and the rotating speed signal is acquired by a rotating speed sensor; and then a rotating frequency is extracted from the rotating speed signal, a time period corresponding to a highest rotating speed state is found based on the rotating frequency, and a vibration signal fragment x∈ [symbol] of the time period is intercepted from the vibration signal as a to-be-processed signal.

In the method, in the second step, the derivative window function short-time Fourier transform is:

$${P}_{x} [ m , n ] = {\sum }_{k = - ∞}^{+ ∞} x [ k ] {g}^{′} [ k - n ] {e}^{- j 2 π mk} , m = 1 , 2 , … , M , n = 1 , 2 , … , N ,$$

wherein, x[k] represents a time-domain vibration signal, g′[k] represents taking a derivative of a window function g[k] as a window function of short-time Fourier transform, and M and N respectively represent a line number and a column number of a time-frequency matrix. Based on the derivative window function short-time Fourier transform, the denoising time-frequency matrix Qₓ∈ [symbol] is constructed:

$${Q}_{x} [ m , n ] = \frac{{P}_{x}^{2} [ m , n ]}{min ( \sqrt{{\sum }_{i = m - δ}^{m} {P}_{x}^{2} [ i , n ]} , \sqrt{{\sum }_{i = m}^{m + δ} {P}_{x}^{2} [ i , n ]} )} , m = 1 , 2 , … , M , n = 1 , 2 , … , N ,$$

wherein, δ is a bandwidth for moving average.

Elements in the denoising time-frequency matrix Qₓ are rearranged into vectors Qₓ^{v}∈ [symbol] in columns, and the weighting matrix W∈ [symbol] is obtained by diagonalizing the vectors Qₓ^{v}:

$$W = diag ( \vert {Q}_{x}^{v} \vert ) ,$$

wherein, diag(⋅) represents obtaining a diagonal matrix by diagonalizing the vectors.

In the method, in the third step, the nonlinear sparse time-frequency enhancement model is:

$$\hat{α} = arg {min}_{α} \{ \frac{1}{2} {‖ A α - x ‖}_{2}^{2} + λ {‖ W α ‖}_{1} \}$$

$${\hat{N}}_{x} = \hat{α} . / {P}_{x}^{v} ,$$

wherein, α∈ [symbol] represents a vibration signal time-frequency coefficient, ∥⋅∥₁ represents a norm regularization, λ is a regular term parameter, the matrix A∈ [symbol] represents linear time-frequency transform, Pₓ^{v}∈ [symbol] is a vector result of the derivative window function short-time Fourier transform, which is obtained by rearranging the derivative window function short-time Fourier transform Pₓ∈ [symbol] in columns, \hat{α}∈ [symbol] represents a solving result of a sparse time-frequency representation model, and \hat{N}ₓ∈ [symbol] represents a solving result of an overall nonlinear sparse time-frequency analysis model.

In the method, in the third step, in the nonlinear sparse enhancement algorithm model, a nonlinear weight W is introduced into the iterative shrinkage threshold algorithm, and the nonlinear weight W is set in a gradient descent step:

$${z}^{( i )} = {α}^{( i - 1 )} - μ {A}^{- 1} {W}^{- 1} ( AW {α}^{( i - 1 )} - x )$$

$${α}^{( i )} = soft ( {z}^{( i )} , λμ ) ,$$

wherein, α⁽ⁱ⁾ represents an iterative optimization result of an i^{th} step, μ represents a step size of gradient descent, the matrix A∈ [symbol] represents linear time-frequency transform, λ represents a regular term parameter, and z⁽ⁱ⁾ represents an intermediate process quantity of iterative optimization. A coefficient is divided by the weight W when short-time Fourier transform is performed on a time-domain signal, and then is multiplied by the weight W in an inverse transform process to ensure reversibility of the coefficient. An operation formula of a soft threshold soft(⋅,⋅) is:

$$soft ( a , τ ) = a \cdot \frac{max \{ \vert a \vert - τ , 0 \}}{max \{ \vert a \vert , τ \}}$$

wherein, a represents a variable for performing a soft threshold operation, and τ represents a threshold.

In the method, in the fourth step, the fast iterative shrinkage threshold algorithm includes the gradient descent, the soft threshold operation and iterative extrapolation, wherein,

$${z}^{( i )} = {v}^{( i - 1 )} - μ {A}^{- 1} ( {Av}^{( i - 1 )} - x )$$

$${α}^{( i )} = soft ( {z}^{( i )} , λμ W )$$

$${t}_{i + 1} = \frac{( 1 + \sqrt{1 + 4 {t}_{i}^{2}} )}{2}$$

$${v}^{( i )} = {α}^{( i )} + \frac{( {t}_{i} - 1 )}{{t}_{i + 1}} ( {α}^{( i )} - {α}^{( i - 1 )} ) ,$$

wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, and soft(⋅,⋅) is the operation formula of the soft threshold.

The k sparse strategy obtains a threshold of the soft threshold operation through a formula T⁽ⁱ⁾=Wq_{[k]}⁽ⁱ⁾, wherein, a superscript i represents an iteration number, q_{[k]}⁽ⁱ⁾ represents a k^{th} largest coefficient in a matrix q⁽ⁱ⁾, the matrix q⁽ⁱ⁾ is obtained by a formula q⁽ⁱ⁾=W⁻¹z⁽ⁱ⁾, then an iterative result of the i^{th} time is obtained through the soft threshold operation α⁽ⁱ⁾=soft(z⁽ⁱ⁾, T(⁽ⁱ⁾), and a soft threshold flow based on the k sparse strategy is completed.

In the method, in the fourth step, the nonlinear sparse enhancement algorithm model is improved by using the fast iterative shrinkage threshold algorithm and combining the k sparse strategy:

$${z}^{( i )} = {v}^{( i - 1 )} - μ {A}^{- 1} {W}^{- 1} ( {AWv}^{( i - 1 )} - x )$$

$${T}^{( i )} = {z}_{[ k ]}^{( i )}$$

$${α}^{( i )} = soft ( {z}^{( i )} , {T}^{( i )} )$$

$${t}_{i + 1} = \frac{( 1 + \sqrt{1 + 4 {t}_{i}^{2}} )}{2}$$

$${v}^{( i )} = {α}^{( i )} + \frac{( {t}_{i -} 1 )}{{t}_{i + 1}} ( {α}^{( i )} - {α}^{( i - 1 )} ) ,$$

wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, z_{[k]}⁽ⁱ⁾ represents a k^{th} largest coefficient in z⁽ⁱ⁾, T⁽ⁱ⁾ represents a threshold of i^{th} iterative optimization, and soft(⋅,⋅) is the operation formula of the soft threshold.

The result obtained by iterative optimization is the nonlinear sparse time-frequency representation result, namely \hat{N}ₓ=\hat{α}.

In the method, in the fifth step, when the instantaneous dynamic frequency ridge rₓ is extracted based on the nonlinear sparse time-frequency representation result \hat{N}ₓ, a point with a largest amplitude within a target frequency range is selected as a start point (K, rₓ[K]) for ridge search, K represents a time coordinate corresponding to the start point, and rₓ[K] represents a frequency coordinate corresponding to the start point; then ridge points are continuously searched in forward and backward directions based on amplitudes of a time-frequency coefficient, and a formula is:

$${r}_{x} [ n ] = \{ \begin{matrix}arg {max}_{m ∈ ℳ [ n ]} \vert {\hat{N}}_{x} [ m , n ] \vert , n = 0 , 1 , … , K - 1 \\ arg {max}_{m ∈ ℳ [ n ]} \vert {\hat{N}}_{x} [ m , n ] \vert , n = K + 1 , K + 2 , … , N - 1\end{matrix} ,$$

wherein, N represents a point number of a time-frequency ridge, and [symbol] [n] is a limited frequency band range relative to a previous moment or subsequent moment when searching for the ridge point at the subsequent moment or previous moment, namely a narrow band range with a frequency at the previous moment or subsequent moment as a center:

$$ℳ [ n ] = \{ \begin{matrix}[ {r}_{x} [ n + 1 ] - {f}_{ω} , {r}_{x} [ n + 1 ] + {f}_{ω} ] , & n = 0 , 1 , … , K - 1 \\ [ {r}_{x} [ n - 1 ] - {f}_{ω} , {r}_{x} [ n - 1 ] + {f}_{ω} ] , & n = K + 1 , K + 2 , … , N - 1\end{matrix} ,$$

wherein, f_{ω} is a half bandwidth.

As for the extracted instantaneous dynamic frequency ridge rₓ, a spectrum feature \tilde{r}ₓ of the ridge is obtained through de-averaging and Fourier transform.

In the method, in the sixth step, a peak value rₚₚᵥ of a time-frequency ridge peak, total energy Eₜ of a ridge spectrum of 0-500 Hz and a proportion Eᵣ of a low-voltage rotating frequency in the spectrum are calculated based on the instantaneous dynamic frequency ridge rₓ and the spectrum feature \tilde{r}ₓ thereof, so as to judge whether an intermediate bearing fault exists, wherein,
the peak value rₚₚᵥ of the time-frequency ridge peak:

$${r}_{p p v} = max ( {r}_{x} ) - min ( {r}_{x} ) ,$$

the total energy Eₜ of the ridge spectrum of 0-500 Hz:

$${E}_{t} = {\sum }_{f = 0}^{500} {\vert {\tilde{r}}_{x} [ f ] \vert}^{2} Δ f ,$$

the proportion Eᵣ of the low-voltage rotating frequency in the spectrum of the time-frequency ridge:

$${E}_{r} = \frac{{\vert {\tilde{r}}_{x} [ {f}_{L} ] \vert}^{2} Δ f}{{\sum }_{f = 0}^{500} {\vert {\tilde{r}}_{x} [ f ] \vert}^{2} Δ f} ,$$

wherein, f_{L} represents the low-voltage rotating frequency, and Δf represents a frequency resolution.

In the method, in the sixth step, based on a distribution histogram of indicators of the intermediate bearing in different states, thresholds of all indicators are determined through statistical analysis, a relevant state indicator is represented by c, and a threshold thereof is determined as follows:
calculating state indicators c of each data and drawing a trend, corresponding to fault-free and faulty intermediate bearings; and
fitting the distribution of two state indicators through two Gaussian function curves to obtain probability density functions fₙ(c) and f_{w} of the distribution of fault-free and faulty state indicators, wherein the adopted Gaussian function is:

$${f}_{n} ( c ) = \frac{1}{{σ}_{n} \sqrt{2 π}} {e}^{- \frac{{( c - {μ}_{n} )}^{2}}{2 {σ}_{n}^{2}}} , f \frac{1}{{σ}_{w} \sqrt{2 π}} {e}^{- \frac{{( c - {μ}_{w} )}^{2}}{2 {σ}_{w}^{2}}} w ,$$

wherein, σₙ and σ_{w} respectively represent a standard deviation of fault-free and faulty data, and μₙ and μ_{w} respectively represent mean values of the fault-free and faulty data.

An intersection point of the two probability density functions is selected as a threshold T_{c} of the state indicators, namely:

$${T}_{c} = c s . t . {f}_{n} ( c ) = {f}_{w} ,$$

when the following conditions are met simultaneously, it is considered that the intermediate bearing has a fault:

$${r}_{ppv} \geq {T}_{r} , {E}_{t} \geq {T}_{E 1} , and {E}_{r} \geq {T}_{E 2} ,$$

wherein, Tᵣ, T_{E1} and T_{E2} respectively represent the thresholds of the three state indicators of the peak value of the time-frequency ridge peak, the total energy of the ridge spectrum of 0-500 Hz and the proportion of the low-voltage rotating frequency in the spectrum of the time-frequency ridge.

Compared with the prior art, the present disclosure has the following advantages:

The present disclosure provides a new instantaneous dynamic frequency-based vibration fault discrimination mode for the intermediate bearing of the aeroengine, that is, whether the intermediate bearing fails is judged through a phenomenon that a high-voltage rotating frequency is modulated by a low-voltage rotating frequency, resulting in dynamic fluctuations. Due to the fact that this fault discrimination mode is only related to the high and low voltage rotating frequencies, and is independent of traditional vibration impact features, it is not affected by the difficulty in fully transmitting the impact features to the vibration test points, making it easier to achieve feature extraction, so that fault diagnosis is completed. In addition, in the present disclosure, the nonlinear sparse time-frequency enhancement model or the nonlinear sparse enhancement algorithm model is constructed, an enhancement effect on nonlinear compression transform weak features is maintained, at the same time, a denoising performance represented by a sparse time frequency is combined, and the defect that the noise is enhanced synchronously, resulting in poor robustness is overcome. Therefore, the vibration signals of the intermediate bearing in the aeroengine are analyzed based on the nonlinear sparse time-frequency enhancement model, and the weak vibration fault features can be effectively enhanced, so that it is conducive to extraction of the instantaneous dynamic frequency features of the intermediate bearing. To sum up, compared to the prior art, the present disclosure can promote the extraction of the vibration fault features of the intermediate bearing in the aeroengine from two aspects: fault feature mode and vibration signal analysis, so that it is more conducive to completing fault diagnosis.

### BRIEF DESCRIPTION OF FIGURES

By reading the detailed description of preferred specific implementations in the following text, various other advantages and benefits of the present disclosure will become clear to those ordinarily skilled in the art. Accompanying drawings of the specification are only intended to illustrate the preferred implementations and are not considered a limitation on the present disclosure. Obviously, the accompanying drawings in the following description are only some embodiments of the present disclosure, and for the ordinarily skilled in the art, on the premise of no creative labor, other accompanying drawings may further be obtained from these accompanying drawings. Moreover, throughout the accompanying drawings, the same elements are represented by the same reference numerals.

In the figures:

FIG. 1 is a schematic diagram of steps of a nonlinear sparsity-based instantaneous dynamic frequency fault diagnosis method for an aviation intermediate bearing according to an embodiment of the present disclosure.

FIG. 2 is a schematic flow chart of a nonlinear sparsity-based instantaneous dynamic frequency fault diagnosis method for an aviation intermediate bearing according to an embodiment of the present disclosure.

FIG. 3 is a structural diagram and a physical diagram of a dual rotor aeroengine fault simulation test bench according to an embodiment of the present disclosure.

FIG. 4 is a schematic diagram of inner ring, outer ring and rolling body faults of an intermediate bearing according to an embodiment of the present disclosure, all of which are crack faults, and a fault degree is 0.4 mm.

FIGS. 5A-D are vibration signal time-domain waveform (acceleration signal) according to an embodiment of the present disclosure, wherein FIGS. 5A-D respectively correspond to a normal bearing, an inner ring fault, an outer ring fault and a rolling body fault.

FIGS. 6A-D are vibration signal spectrum according to an embodiment of the present disclosure, marked with corresponding high and low voltage rotating frequencies, wherein FIGS. 6A-D respectively correspond to a normal bearing, an inner ring fault, an outer ring fault and a rolling body fault.

FIGS. 7A-D are time-frequency analysis result of a vibration signal based on nonlinear sparse time-frequency enhancement according to an embodiment of the present disclosure, extracting a time-frequency ridge near a high-voltage rotating frequency by utilizing a ridge searching algorithm, which is marked in a time-frequency map, wherein FIGS. 7A-D respectively correspond to a normal bearing, an inner ring fault, an outer ring fault and a rolling body fault.

FIGS. 8A-D are spectrums of a time-frequency ridge near a high-voltage rotating frequency of a vibration signal according to an embodiment of the present disclosure, wherein FIGS. 8A-D respectively correspond to a normal bearing, an inner ring fault, an outer ring fault and a rolling body fault.

The present disclosure is further explained in conjunction with the accompanying drawings and embodiments below.

### DETAILED DESCRIPTION

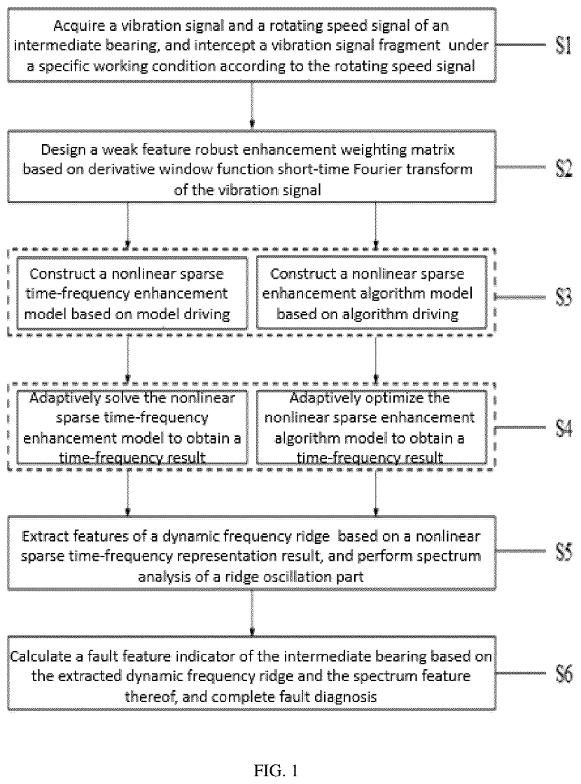

The specific embodiments of the present disclosure will be described in further detail with reference to FIG. 1 to FIG. 8D. Although the specific embodiments of the present disclosure are shown in the accompanying drawings, it should be understood that the present disclosure may be implemented in various forms and should not be limited by the embodiments set forth herein. Rather, these embodiments are provided so that the present disclosure can be understood more thoroughly, and can fully convey the scope of the present disclosure to those skilled in the art.

It should be noted that certain terms are used in the specification and claims to refer to specific components. Those skilled in the art should understand that they may use different nouns to refer to the same component. The specification and claims do not differentiate components based on differences in terms of nouns, but rather on differences in functionality between components. If the term “contain” or “include” mentioned throughout the entire specification and claims is an open term, it should be interpreted as “including but not limited to”. The subsequent description of the specification is preferred implementations to implement the present disclosure. However, the description is for the purpose of explaining general principles of the present disclosure and is not intended to limit the scope of the present disclosure. It is intended that the protection scope of the present disclosure is only limited by the appended claims.

For the purpose of facilitating the understanding of the embodiments of the present disclosure, further explanations will be provided using the specific embodiments as examples in conjunction with the accompanying drawings, and each accompanying drawing does not constitute a limitation on the embodiments of the present disclosure.

For a better understanding, FIG. 1 is a schematic diagram of steps of a nonlinear sparsity-based instantaneous dynamic frequency fault diagnosis method for an aviation intermediate bearing according to an embodiment of the present disclosure. As shown in FIG. 1, a nonlinear sparsity-based instantaneous dynamic frequency fault diagnosis method for an aviation intermediate bearing includes the following steps:
in a first step S1, appropriate test points are selected, a vibration signal and a rotating speed signal of high and low voltages of the intermediate bearing are acquired, and a vibration signal fragment x∈ [symbol] under a specific working condition is intercepted according to the rotating speed signal;
in a second step S2, derivative window function short-time Fourier transform Pₓ∈ [symbol] is performed based on the vibration signal, and a weak feature robust enhancement weighting matrix W∈ [symbol] is designed by using different distribution characteristics of a signal component and noise in a time-frequency plane;
in a third step S3, the weighting matrix W is combined, and through a mode of model driving or algorithm driving, a nonlinear sparse time-frequency enhancement model or a nonlinear sparse enhancement algorithm model is established based on a weighted sparse time-frequency representation model or an iterative shrinkage threshold algorithm;
in a fourth step S4, the nonlinear sparse time-frequency enhancement model is solved or the nonlinear sparse enhancement algorithm model is improved by using a fast iterative shrinkage threshold algorithm and combining a k sparse strategy, and finally a nonlinear sparse time-frequency representation result \hat{N}ₓ∈ [symbol] may be obtained through iterative optimization;
in a fifth step S5, features of an instantaneous dynamic frequency ridge near a high-voltage rotating frequency are extracted based on the nonlinear sparse time-frequency representation result \hat{N}ₓ, and spectrum analysis of a ridge oscillation part is performed to complete feature extraction; and
in a sixth step S6, a fault feature indicator of the intermediate bearing is calculated based on the extracted dynamic frequency ridge and the spectrum feature thereof, and the fault feature indicator is compared with a preset threshold to complete fault diagnosis.

In a preferred implementation of the method, in the first step, the vibration signal is acquired by a vibration acceleration sensor, vibration test points are arranged at other bearing support points closest to the intermediate bearing, and the rotating speed signal is acquired by a rotating speed sensor; and then a rotating frequency is extracted from the rotating speed signal, a time period corresponding to a highest rotating speed state is found based on the rotating frequency, and a vibration signal fragment x∈ [symbol] of the time period is intercepted from the vibration signal as a to-be-processed signal.

In the preferred implementation of the method, in the second step, the derivative window function short-time Fourier transform is:

$${P}_{x} [ m , n ] = {\sum }_{k = - ∞}^{+ ∞} x [ k ] {g}^{′} [ k - n ] {e}^{- j 2 π mk} , m = 1 , 2 , … , M , n = 1 , 2 , … , N ,$$

wherein, x[k] represents a time-domain vibration signal, g′[k] represents taking a derivative of a window function g[k] as a window function of short-time Fourier transform, and M and N respectively represent a line number and a column number of a time-frequency matrix. Based on the derivative window function short-time Fourier transform, the denoising time-frequency matrix Qₓ∈ [symbol] is constructed:

$${Q}_{x} [ m , n ] = \frac{{P}_{x}^{2} [ m , n ]}{min ( \sqrt{{\sum }_{i = m - δ}^{m} {P}_{x}^{2} [ i , n ]} , \sqrt{{\sum }_{i = m}^{m + δ} {P}_{x}^{2} [ i , n ]} )} , \\ m = 1 , 2 , … , M , n = 1 , 2 , … , N ,$$

wherein, δ is a bandwidth for moving average.

Elements in the denoising time-frequency matrix Qₓ are rearranged into vectors Qₓ^{v}∈ [symbol] in columns, and the weighting matrix W∈ [symbol] is obtained by diagonalizing the vectors Qₓ^{v}:

$$W = diag ( \vert {Q}_{x}^{v} \vert ) ,$$

wherein, diag(⋅) represents obtaining a diagonal matrix by diagonalizing the vectors.

In the preferred implementation of the method, in the third step, the nonlinear sparse time-frequency enhancement model is:

$$\hat{a} = arg {min}_{α} \{ \frac{1}{2} {‖ A α - x ‖}_{2}^{2} + λ {‖ W α ‖}_{1} \}$$

$${\hat{N}}_{x} = \hat{α} . / {P}_{x}^{v} ,$$

wherein, α∈ [symbol] represents a vibration signal time-frequency coefficient, ∥⋅∥₁ represents a norm regularization, λ is a regular term parameter, the matrix A∈ [symbol] represents linear time-frequency transform, Pₓ^{v}∈ [symbol] is a vector result of the derivative window function short-time Fourier transform, which is obtained by rearranging the derivative window function short-time Fourier transform Pₓ∈ [symbol] in columns, \hat{α}∈ [symbol] represents a solving result of a sparse time-frequency representation model, and \hat{N}ₓ∈ [symbol] represents a solving result of an overall nonlinear sparse time-frequency analysis model.

In the preferred implementation of the method, in the third step, in the nonlinear sparse enhancement algorithm model, a nonlinear weight W is introduced into the iterative shrinkage threshold algorithm, and the nonlinear weight W is set in a gradient descent step:

$${z}^{( i )} = {α}^{( i - 1 )} - μ {A}^{- 1} {W}^{- 1} ( {AWα}^{( i - 1 )} - x )$$

$${α}^{( i )} = soft ( {z}^{( i )} , λμ ) ,$$

wherein, α⁽ⁱ⁾ represents an iterative optimization result of an i^{th} step, μ represents a step size of gradient descent, the matrix A∈ [symbol] represents linear time-frequency transform, λ represents a regular term parameter, and z⁽ⁱ⁾ represents an intermediate process quantity of iterative optimization. A coefficient is divided by the weight W when short-time Fourier transform is performed on a time-domain signal, and then is multiplied by the weight W in an inverse transform process to ensure reversibility of the coefficient. An operation formula of a soft threshold soft(⋅,⋅) is:

$$soft ( a , τ ) = a \cdot \frac{max \{ \vert a \vert - τ , 0 \}}{max \{ \vert a \vert , τ \}} ,$$

wherein, a represents a variable for performing a soft threshold operation, and τ represents a threshold.

In the preferred implementation of the method, in the fourth step, the fast iterative shrinkage threshold algorithm includes the gradient descent, the soft threshold operation and iterative extrapolation, wherein,

$${z}^{( i )} = {v}^{( i - 1 )} - μ {A}^{- 1} ( {Av}^{( i - 1 )} - x )$$

$${α}^{( i )} = soft ( {z}^{( i )} , λμ W )$$

wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, and soft(⋅,⋅) is the operation formula of the soft threshold.

The k sparse strategy obtains a threshold of the soft threshold operation through a formula T⁽ⁱ⁾=Wq_{[k]}⁽ⁱ⁾, wherein a superscript i represents an iteration number, q_{[k]}⁽ⁱ⁾ represents a k^{th} largest coefficient in a matrix q⁽ⁱ⁾, the matrix q⁽ⁱ⁾ is obtained by a formula q⁽ⁱ⁾=W⁻¹z⁽ⁱ⁾, then an iterative result of the i^{th} time is obtained through the soft threshold operation α⁽ⁱ⁾=soft(z⁽ⁱ⁾, T⁽ⁱ⁾), and a soft threshold flow based on the k sparse strategy is completed.

In the preferred implementation of the method, in the fourth step, the nonlinear sparse enhancement algorithm model is improved by using the fast iterative shrinkage threshold algorithm and combining the k sparse strategy:

$$\begin{matrix}{z}^{( i )} = {v}^{( i - 1 )} - μ {A}^{- 1} {W}^{- 1} ( {AWv}^{( i - 1 )} - x ) \\ {T}^{( i )} = {z}_{[ k ]}^{( i )} \\ {α}^{( i )} = soft ( {z}^{( i )} , {T}^{( i )} ) \\ {t}_{i + 1} = \frac{( 1 + \sqrt{1 + 4 {t}_{i}^{2}} )}{2} \\ {v}^{( i )} = {α}^{( i )} + \frac{( {t}_{i} - 1 )}{{t}_{i + 1}} ( {α}^{( i )} - {α}^{( i - 1 )} ) ,\end{matrix}$$

wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, z_{[k]}⁽ⁱ⁾ represents a k^{th} largest coefficient in z⁽ⁱ⁾, T⁽ⁱ⁾ represents a threshold of i^{th} iterative optimization, and soft(⋅,⋅) is the operation formula of the soft threshold.

The result obtained by iterative optimization is the nonlinear sparse time-frequency representation result, namely \hat{N}ₓ=\hat{α}.

In the preferred implementation of the method, in the fifth step, when the instantaneous dynamic frequency ridge rₓ is extracted based on the nonlinear sparse time-frequency representation result \hat{N}ₓ, a point with a largest amplitude within a target frequency range is selected as a start point (K, rₓ[K]) for ridge search, K represents a time coordinate corresponding to the start point, and rₓ[K] represents a frequency coordinate corresponding to the start point; then ridge points are continuously searched in forward and backward directions based on amplitudes of a time-frequency coefficient, and a formula is:

$${r}_{x} [ n ] = \{ \begin{matrix}arg {max}_{m ∈ ℳ [ n ]} \vert {\hat{N}}_{x} [ m , n ] \vert , & n = 0 , 1 , … , K - 1 \\ arg {max}_{m ∈ ℳ [ n ]} \vert {\hat{N}}_{x} [ m , n ] \vert , & n = K + 1 , K + 2 , … , N - 1\end{matrix} ,$$

wherein, N represents a point number of a time-frequency ridge, and [symbol] [n] is a limited frequency band range relative to a previous moment or subsequent moment when searching for the ridge point at the subsequent moment or previous moment, namely a narrow band range with a frequency at the previous moment or subsequent moment as a center:

$$ℳ [ n ] = \{ \begin{matrix}[ {r}_{x} [ n + 1 ] - {f}_{ω} , {r}_{x} [ n + 1 ] + {f}_{ω} ] , & n = 0 , 1 , … , K - 1 \\ [ {r}_{x} [ n - 1 ] - {f}_{ω} , {r}_{x} [ n - 1 ] + {f}_{ω} ] , & n = K + 1 , K + 2 , … , N - 1\end{matrix} ,$$

wherein, f_{ω} is a half bandwidth.

As for the extracted instantaneous dynamic frequency ridge rₓ, a frequency spectrum feature \tilde{r}ₓ of the ridge is obtained through de-averaging and Fourier transform.

In the preferred implementation of the method, in the sixth step, a peak value rₚₚᵥ of a time-frequency ridge peak, total energy Eₜ of a ridge spectrum of 0-500 Hz and a proportion Eᵣ of a low-voltage rotating frequency in the spectrum are calculated based on the instantaneous dynamic frequency ridge rₓ and the spectrum feature \tilde{r}ₓ thereof, so as to judge whether an intermediate bearing fault exists, wherein,
the peak value rₚₚᵥ of the time-frequency ridge peak:

$${r}_{ppv} = max ( {r}_{x} ) - min ( {r}_{x} ) ,$$

the total energy Eₜ of the ridge spectrum of 0-500 Hz:

$${E}_{t} = {\sum }_{f = 0}^{500} {\vert {\tilde{r}}_{x} [ f ] \vert}^{2} Δ f ,$$

the proportion Eᵣ of the low-voltage rotating frequency in the spectrum of the time-frequency ridge:

$${E}_{r} = \frac{{\vert {\tilde{r}}_{x} [ {f}_{L} ] \vert}^{2} Δ f}{{\sum }_{f = 0}^{500} {\vert {\tilde{r}}_{x} [ f ] \vert}^{2} Δ f} ,$$

wherein, f_{L} represents the low-voltage rotating frequency, and Δf represents a frequency resolution.

In the preferred implementation of the method, in the sixth step, based on a distribution histogram of indicators of the intermediate bearing in different states, thresholds of all indicators are determined through statistical analysis, a relevant state indicator is represented by c, and a threshold thereof is determined as follows:
state indicators c of each data are calculated and a trend is drawn, which correspond to fault-free and faulty intermediate bearings; and
the distribution of two state indicators is fitted through two Gaussian function curves to obtain probability density functions fₙ(c) and f_{w}of the distribution of fault-free and faulty state indicators, wherein the adopted Gaussian function is:

$${f}_{n} ( c ) = \frac{1}{{σ}_{n} \sqrt{2 π}} {e}^{- \frac{{( c - {μ}_{n} )}^{2}}{2 {σ}_{n}^{2}}} , f \frac{1}{{σ}_{w} \sqrt{2 π}} {{e}^{- \frac{{( c - {μ}_{w} )}^{2}}{2 {σ}_{w}^{2}}}}_{w} ,$$

wherein, σₙ and σ_{w} respectively represent a standard deviation of fault-free and faulty data, and μₙ and μ_{w} respectively represent mean values of the fault-free and faulty data.

An intersection point of the two probability density functions is selected as a threshold T_{c} of the state indicators, namely:

$${T}_{c} = c s . t . {f}_{n} ( c ) = {f}_{w} ,$$

when the following conditions are met simultaneously, it is considered that the intermediate bearing has a fault:

$${r}_{ppv} \geq {T}_{r} , {E}_{t} \geq {T}_{E 1} , and {E}_{r} \geq {T}_{E 2} ,$$

wherein, Tᵣ, T_{E1} and T_{E2} respectively represent the thresholds of the three state indicators of the peak value of the time-frequency ridge peak, the total energy of the ridge spectrum of 0-500 Hz and the proportion of the low-voltage rotating frequency in the spectrum of the time-frequency ridge.

In order to further understand the present disclosure, in one embodiment, FIG. 1 is a schematic diagram of steps of a nonlinear sparsity-based instantaneous dynamic frequency fault diagnosis method for an aviation intermediate bearing, including the following steps:

S1, appropriate test points are selected, a vibration signal and a rotating speed signal of high and low voltages of the intermediate bearing are acquired, and a vibration signal fragment x∈ [symbol] under a specific working condition is intercepted according to the rotating speed signal;
S2, derivative window function short-time Fourier transform Pₓ∈ [symbol] is performed based on the vibration signal, and a weak feature robust enhancement weighting matrix W∈ [symbol] is designed by using different distribution characteristics of a signal component and noise in a time-frequency plane;
S3, the weighting matrix W is combined, and through a mode of model driving or algorithm driving, a nonlinear sparse time-frequency enhancement model or a nonlinear sparse enhancement algorithm model is established based on a weighted sparse time-frequency representation model or an iterative shrinkage threshold algorithm;
S4, the nonlinear sparse time-frequency enhancement model is solved or the nonlinear sparse enhancement algorithm model is improved by using a fast iterative shrinkage threshold algorithm and combining a k sparse strategy, and finally a nonlinear sparse time-frequency representation result \hat{N}ₓ∈ [symbol] may be obtained through iterative optimization;
S5, features of an instantaneous dynamic frequency ridge near a high-voltage rotating frequency are extracted based on the nonlinear sparse time-frequency representation result \hat{N}ₓ, and spectrum analysis of a ridge oscillation part is performed to complete feature extraction; and
S6, a fault feature indicator of the intermediate bearing is calculated based on the extracted dynamic frequency ridge and the spectrum feature thereof, and the fault feature indicator is compared with a preset threshold to complete fault diagnosis.

The above embodiments constitute the complete technical solution of the present disclosure, different from the prior art, in the nonlinear sparsity-based instantaneous dynamic frequency fault diagnosis method for the aviation intermediate bearing constructed in the above embodiment, whether the intermediate bearing fails is judged through a phenomenon that a high-voltage rotating frequency is modulated by a low-voltage rotating frequency, resulting in dynamic fluctuations. Due to the fact that this fault discrimination mode is only related to the high and low voltage rotating frequencies, and is independent of traditional vibration impact features, it is not affected by the difficulty in fully transmitting the impact features to vibration test points, making it easier to achieve feature extraction, so that fault diagnosis is completed. In addition, in the above embodiments, the nonlinear sparse time-frequency enhancement model or the nonlinear sparse enhancement algorithm model is constructed, an enhancement effect on nonlinear compression transform weak features is maintained, at the same time, a denoising performance represented by a sparse time frequency is combined, and the defect that the noise is enhanced synchronously, resulting in poor robustness is overcome. Therefore, the vibration signal of the intermediate bearing in the aeroengine is analyzed based on the nonlinear sparse time-frequency enhancement model, and the weak vibration fault features can be effectively enhanced, so that it is conducive to extraction of the instantaneous dynamic frequency features of the intermediate bearing.

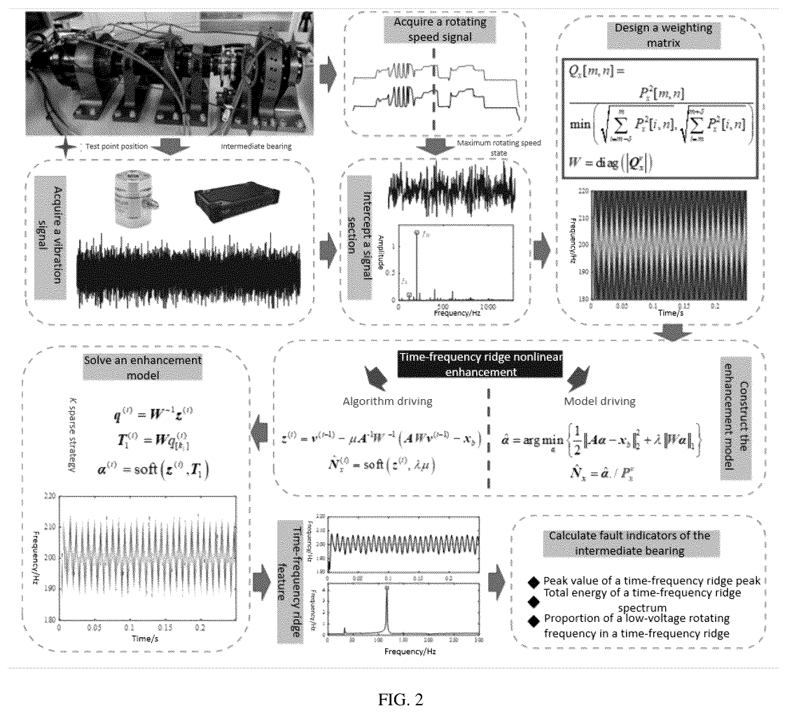

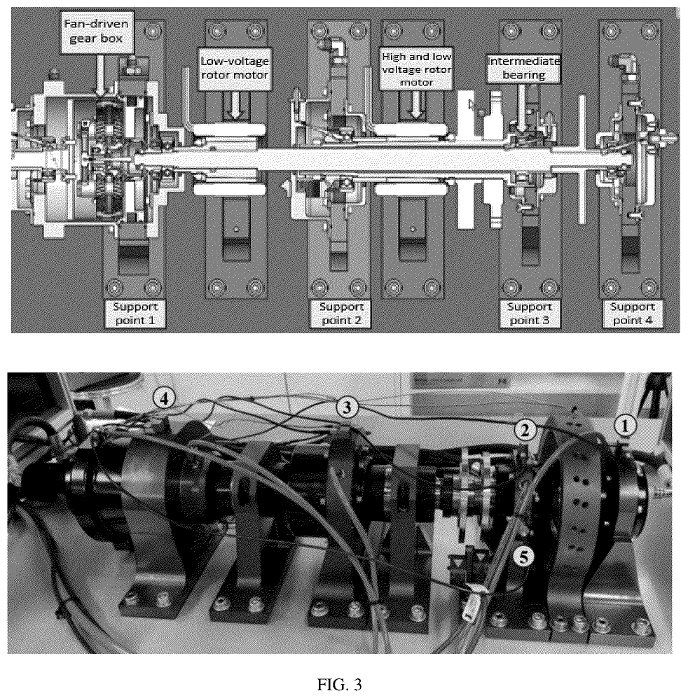

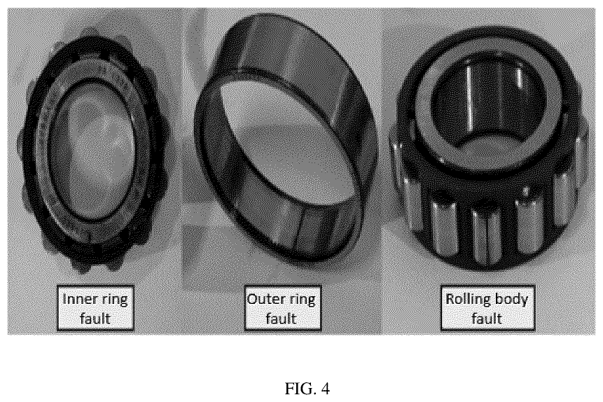

FIG. 2 is a schematic flow chart of a nonlinear sparsity-based instantaneous dynamic frequency fault diagnosis method for an aviation intermediate bearing according to an embodiment of the present disclosure, which more vividly illustrates the relationship between various steps in the present disclosure and the role of the nonlinear sparse time-frequency enhancement method in the instantaneous dynamic frequency fault diagnosis flow for the intermediate bearing of the aeroengine. It should be noted that in this embodiment, the nonlinear sparse time-frequency enhancement method based on model driving is selected to analyze vibration data, and similar results can also be obtained by the method based on algorithm driving.

FIG. 3 is a structural diagram and a physical diagram of a dual rotor aeroengine fault simulation test bench. The test bench simulates an aeroengine dual rotor structure, containing a rotor system, a main bearing, a gear box and other engine simulation components, so as to perform relevant fault simulation tests. There are four support points on the test bench to support high and low voltage rotors, the low-voltage rotors are supported on a support point 1 and a support point 4, left sides of the high-voltage rotors are supported on a support point 2, and the right sides of the high-voltage rotors are supported on the low-voltage rotors through an intermediate bearing at a support point 3. The high and low voltage rotors are driven by a motor respectively, one gear box is connected to the left sides of the low-voltage rotors, and the gear box simulates a fan-driven gear box structure.

On the dual rotor aeroengine fault simulation test bench, an inner ring fault, an outer ring fault and a rolling body fault with a fault degree of 0.4 mm are preset on the intermediate bearing at the support point 3 respectively, so as to perform the fault simulation test of the intermediate bearing of the aeroengine. FIG. 4 is three fault diagrams of the intermediate bearing. Vibration sensors are installed at vertical positions of the support point 1 to the support point 4 of the test bench respectively to monitor vibration of the intermediate bearing in a vertical direction, sensor numbers are 1 to 4 respectively from right to left, and a fifth vibration sensor is installed at a horizontal position of the support point 3 to monitor vibration of the intermediate bearing in a horizontal direction. In a testing process, high and low voltage rotating speeds of the test bench are increased to 12000 r/min and 7000 r/min respectively step by step, following the principle of first increasing the speed of the high-voltage rotors and first decreasing the speed of the low-voltage rotors, which ensures that the rotating speed of the high-voltage rotors is always higher than that of the low-voltage rotors.

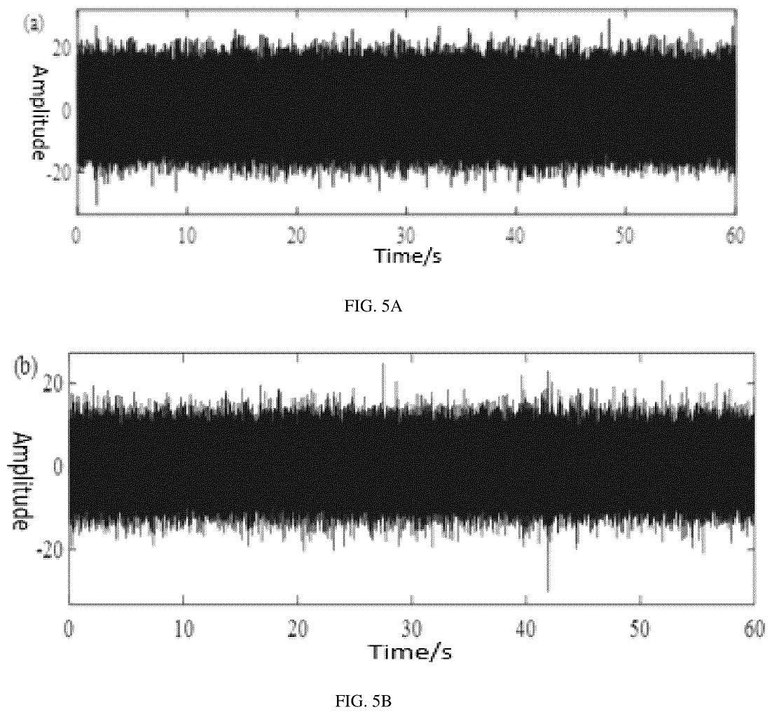

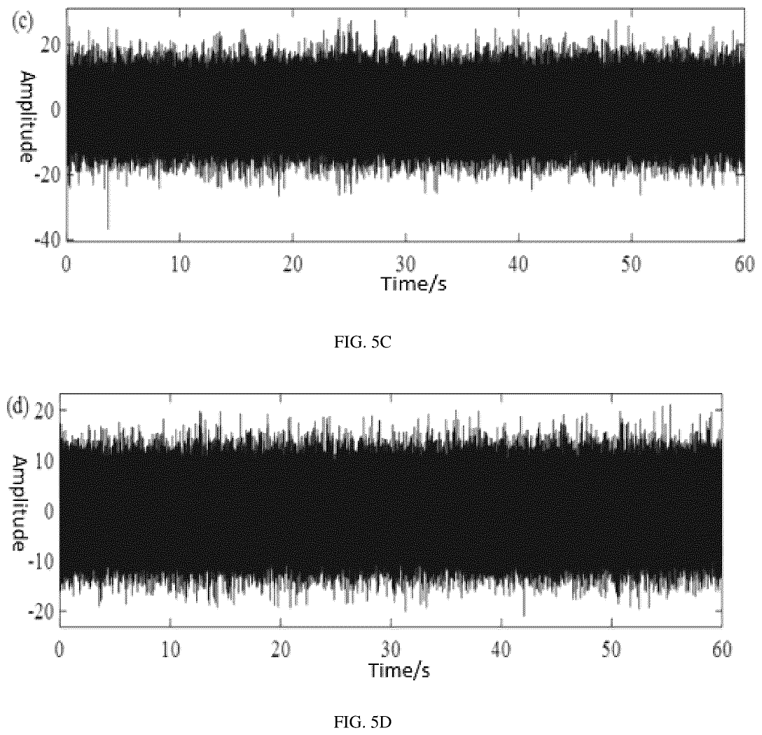

In this embodiment, in step S1, the vibration signal is acquired through an eddy current acceleration sensor, after the high and low voltage rotors reach preset rotating speeds, vibration data is stored, a sampling frequency is 20480 Hz, and a sampling duration is 60 s. Since a supporting mode at the intermediate bearing is that the high and low voltage rotors support each other, an inner ring and an outer ring of the bearing are connected with the low-voltage rotors and the high-voltage rotors respectively. Different from the other three bearings, there is no direct contact between the intermediate bearing and a bearing support, and the bearing support at the support point 3 only plays a role in sealing. Therefore, the vibration signal cannot be transmitted to a second sensor and the fifth sensor, a first sensor becomes a sensor closest to a fault source, so data of the first sensor is selected to perform comparison analysis between a normal bearing and the vibration signal of each faulty bearing, and FIGS. 5A-D shows a waveform of the vibration signal acquired by the first sensor. In addition, the rotating speeds of the high and low voltage rotors are acquired through a rotating speed sensor, and the sampling frequency is 20480 Hz similarly. Then, the above vibration signal is subjected to bandpass filtering according to the high and low voltage rotating frequencies, a spectrum is limited within a range from the high-voltage rotating frequency to a high and low voltage sum frequency, preparing for subsequent time-frequency analysis.

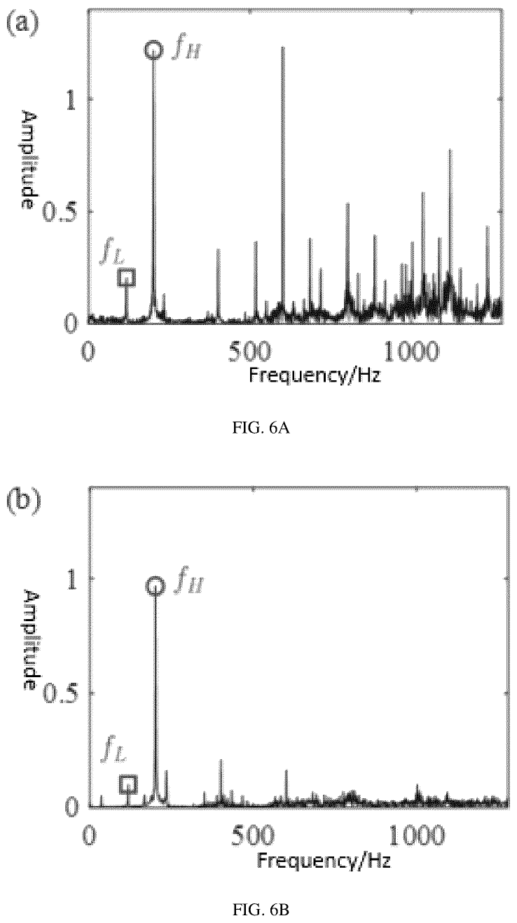

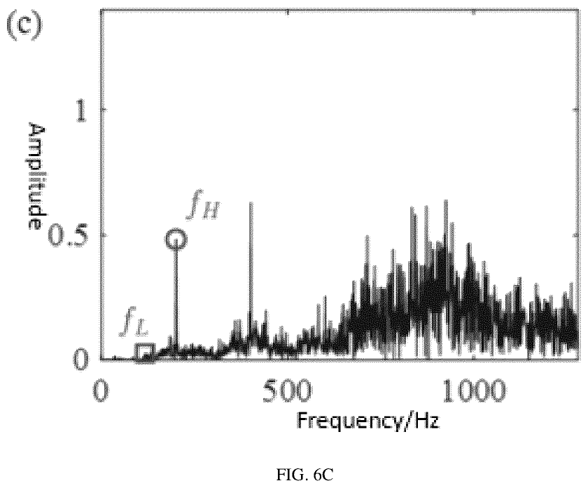

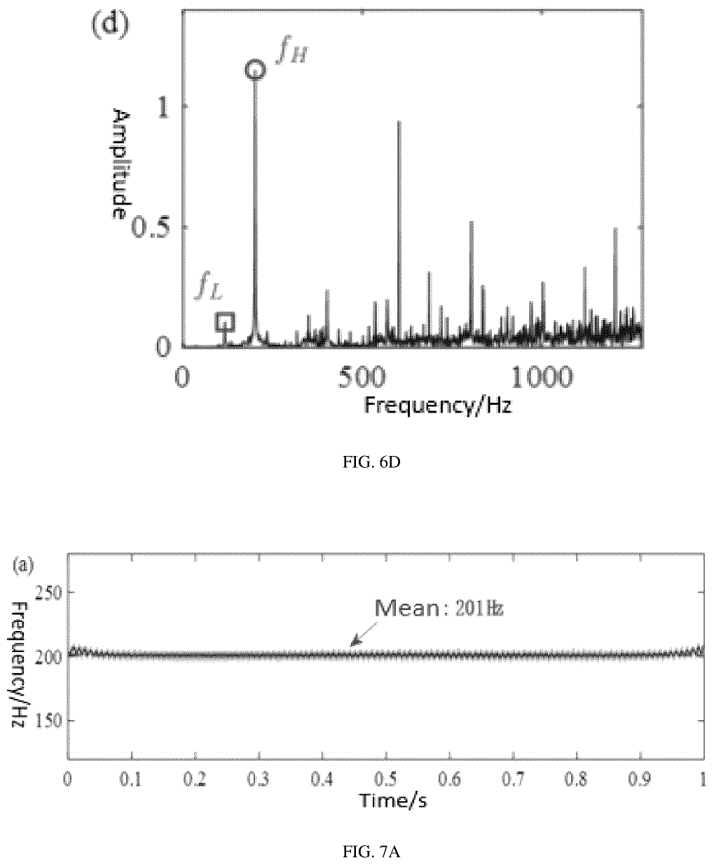

In order to know a specific situation of the vibration signal, a spectrum of the vibration signal is calculated and observed, as shown in FIGS. 6A-D. It may be found from the spectrum graph that all four groups of vibration signals have obvious high-voltage rotating frequency components, while low-voltage rotating frequency components are relatively weak, especially for the vibration signals of the outer ring fault. In addition, the high-frequency components in the vibration signals of the normal bearing and the rolling body fault are relatively rich, while there is a large amount of noise interference in the high-frequency part in the vibration signals of the outer ring fault.

In this embodiment, in step S2, firstly an appropriate window function width is selected, a Gaussian window and a moving step size are selected by default, derivative window function short-time Fourier transform Pₓ of the vibration signal is calculated, then an appropriate moving average bandwidth δ is set, and a weighting matrix W is calculated. Parameters involved in the vibration data of the four states are shown in Table 1.

TABLE 1
Vibration signal analysis time-frequency
parameters in embodiments

| Vibration | Window | Window moving | Moving average |
|---|---|---|---|
| signal | width | step size | bandwidth δ |
| Normal bearing | 20480 | 10 | 10 |
| Inner ring fault | 20480 | 10 | 10 |
| Outer ring fault | 20480 | 10 | 10 |
| Rolling body fault | 20480 | 10 | 10 |

In this embodiment, in step S3, an appropriate regular term parameter λ is selected based on noise intensity in the vibration signal, and the nonlinear sparse time-frequency enhancement model in this embodiment is finally established according to the weighting matrix W calculated in the previous step:

$$\hat{α} = arg {min}_{α} \{ \frac{1}{2} {‖ A α - x ‖}_{2}^{2} + λ {‖ W α ‖}_{1} \}$$

$${\hat{N}}_{x} = \hat{α} . / {P}_{x}^{v}$$

Since the model is solved by adopting the k sparse strategy, the regular term parameter λ in the model does not need to be determined in advance, but is adaptively determined during optimization based on the number of a feature coefficient k to be retained.

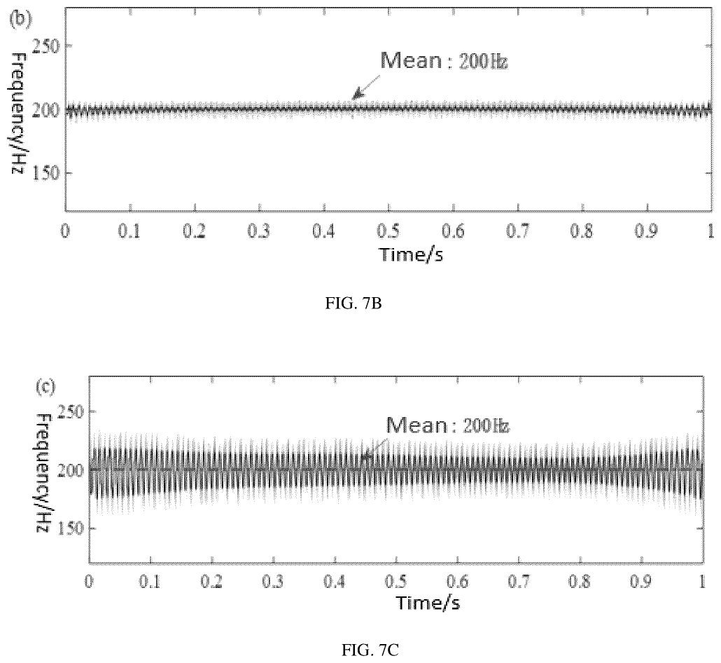

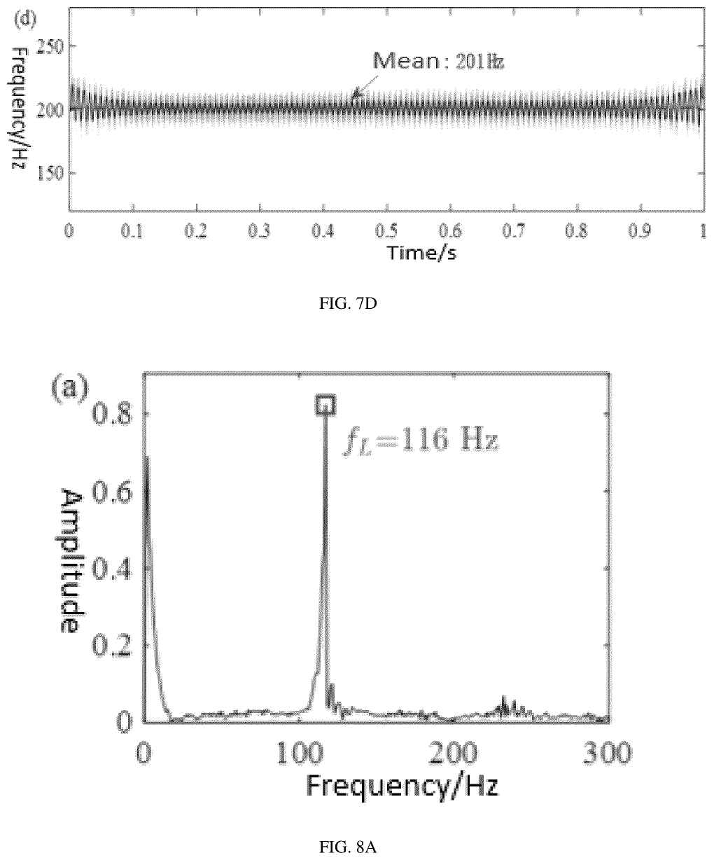

In this embodiment, in step S4, the nonlinear sparse time-frequency enhancement model is solved based on the fast iterative shrinkage threshold algorithm and combining with the k sparse strategy, the algorithm mainly solves the weighted sparse time-frequency representation model, and a subsequent nonlinear matching collaborative enhancement step may be directly calculated according to an optimization result. In the solution of the fast iterative shrinkage threshold algorithm, according to a Lipschitz constant of the gradient, μ=1 is set, and tᵢ=1, z⁽ⁱ⁾=0 and v⁽ⁱ⁾=0 are initialized. FIGS. 7A-C is a time-frequency diagram of the solved vibration signal, from which it may be found that in a time-frequency diagram of the vibration signals when the outer ring and the rolling body of the bearing fail, a time-frequency ridge near the high-voltage rotating frequency oscillates fast, oscillation of a time-frequency ridge is relatively not obvious when the inner ring fails, and the time-frequency ridge almost does not oscillate when the bearing is normal.

In this embodiment, in step S5, firstly a ridge search range is set to be within a 100 Hz bandwidth range with the high-voltage rotating frequency as a center, that is, f_{ω}=50 Hz is set. Then, a weighting coefficient eₖ[n] for adjusting a relative relationship between a frequency point distance and a magnitude of a time-frequency point coefficient is calculated based on a feature amplitude of a time-frequency representation coefficient and a magnitude of the set bandwidth. Finally, the time-frequency ridge is searched within a frequency band range, and is regarded as a high-voltage rotating frequency ridge. The extracted high-voltage rotating frequency ridge is marked in the time-frequency diagrams shown in FIGS. 7A-C, it may be further found that the high-voltage rotating frequency ridge of the vibration signals oscillates fast when the outer ring and the rolling body of the bearing fail, oscillation of the time-frequency ridge is relatively not obvious when the inner ring fails, and the time-frequency ridge almost does not oscillate when the bearing is normal.

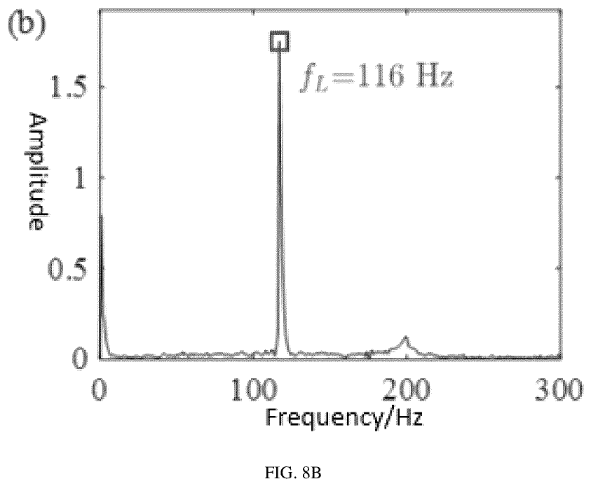

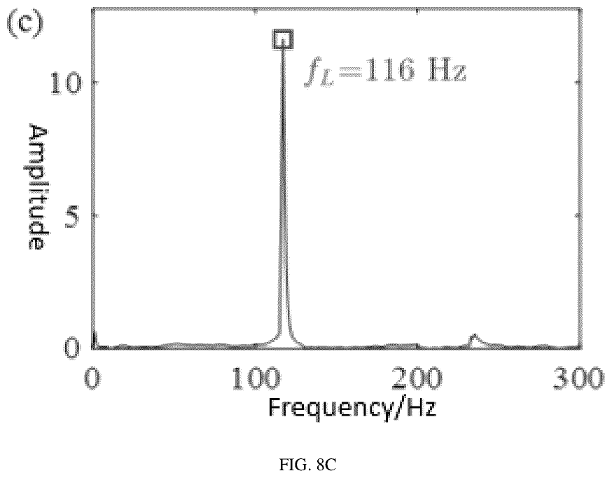

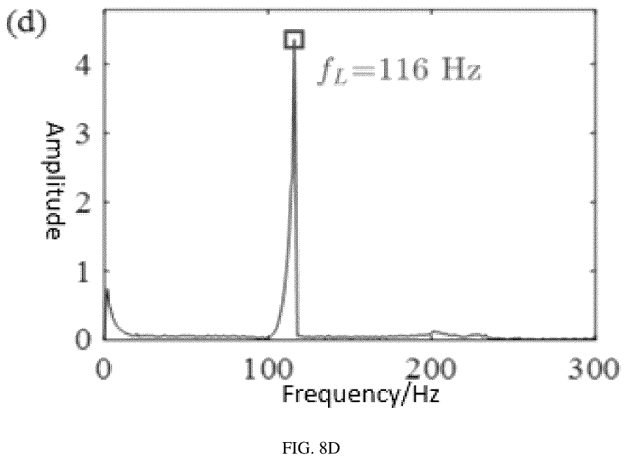

Then, the extracted time-frequency ridge is subjected to de-averaging, the influence of direct current components is eliminated, and a ridge spectrum is calculated through Fourier transform, as shown in FIGS. 8A-D. A feature frequency with a largest amplitude is extracted from the obtained ridge spectrum, and is marked in the graph. It may be found that the largest feature frequencies in the ridge spectra of the vibration signals in four states are all close to the low-voltage rotating frequency, the amplitude of the feature frequency is large when the outer ring and the rolling body of the bearing fail, is small when the inner ring fails, and is smallest when the bearing is normal.

In this embodiment, in step S6, state indicators, namely a peak value rₚₚᵥ of a ridge peak, energy Eₜ of a ridge spectrum and a proportion Eᵣ of a low-voltage rotating frequency, of the vibration signals in four states are calculated respectively and listed in Table 2. It may be found from the comparison of magnitudes of indicator values in four states that the three indicators are all large when the outer ring and the rolling body of the bearing fail, are relatively small when the inner ring fails, and are smallest when the bearing is normal, so as to indicate the effectiveness of the diagnosis flow and discrimination indicators of the intermediate bearing for the fault detection and diagnosis of the outer ring and the rolling body of the intermediate bearing, and a certain differentiation between the inner ring fault and the normal state is also achieved.

TABLE 2
Fault discrimination indicators for intermediate bearing

| | | | Proportion Eᵣ of a |
|---|---|---|---|
| Indicator | Peak value rₚₚᵥ of a | Energy Eₜ of a ridge | low-voltage rotating |
| Bearing state | ridge peak | spectrum | frequency |
| Normal bearing | 9 | 2.9 | 23.4% |
| Inner ring fault | 12 | 5.5 | 56.0% |
| Outer ring fault | 44 | 224.6 | 60.2% |
| Rolling body fault | 33 | 43.4 | 43.7% |

Although the implementation solution of the present disclosure is described above in conjunction with the accompanying drawings, the present disclosure is not limited to the above specific implementation solution and application field, and the above specific implementation solution is only illustrative and guiding, not restrictive. Those ordinarily skilled in the art may make various forms under the inspiration of the specification and without departing from the scope of protection of the claims of the present disclosure, all of which belong to the scope of protection of the present disclosure.

1-10. (canceled)

11. A nonlinear sparsity-based instantaneous dynamic frequency fault diagnosis method for an aviation intermediate bearing, comprising the following steps:
in a first step (S1), acquiring a vibration signal and a rotating speed signal of the intermediate bearing, and intercepting a vibration signal fragment x∈ [symbol] under a specific working condition according to the rotating speed signal;
in a second step (S2), performing derivative window function short-time Fourier transform Pₓ∈ [symbol] based on the vibration signal fragment x∈ [symbol] , constructing a denoising time-frequency matrix Qₓ∈ [symbol] based on the derivative window function short-time Fourier transform Pₓ∈ [symbol] , and obtaining a weighting matrix W∈ [symbol] by diagonalizing the denoising time-frequency matrix Qₓ∈ [symbol] ;
in a third step (S3), establishing a nonlinear sparse time-frequency enhancement model or a nonlinear sparse enhancement algorithm model based on the weighting matrix W;
in a fourth step (S4), solving the nonlinear sparse time-frequency enhancement model or improving the nonlinear sparse enhancement algorithm model by using a fast iterative shrinkage threshold algorithm and combining a k sparse strategy, and obtaining a nonlinear sparse time-frequency representation result \hat{N}ₓ∈ [symbol] through iterative optimization;
in a fifth step (S5), extracting an instantaneous dynamic frequency ridge based on the nonlinear sparse time-frequency representation result \hat{N}ₓ, and obtaining a spectrum feature by performing spectrum analysis of a ridge oscillation part; and
in a sixth step (S6), calculating a fault feature indicator of the intermediate bearing based on the instantaneous dynamic frequency ridge and the spectrum feature thereof, and comparing the fault feature indicator with a preset threshold to complete fault diagnosis.

12. The method according to claim 11, wherein in the first step (S1), the vibration signal is acquired by a vibration acceleration sensor, vibration test points are arranged at other bearing support points closest to the intermediate bearing, and the rotating speed signal is acquired by a rotating speed sensor; and then a rotating frequency is extracted from the rotating speed signal, a time period corresponding to a highest rotating speed state is found based on the rotating frequency, and a vibration signal fragment x∈ [symbol] of the time period is intercepted from the vibration signal as a to-be-processed signal.

13. The method according to claim 11, wherein in the second step (S2), the derivative window function short-time Fourier transform is:
$${P}_{x} [ m , n ] = {\sum }_{k = - ∞}^{+ ∞} x [ k ] {g}^{′} [ k - n ] {e}^{- j 2 π mk} , m = 1 , 2 , … , M , n = 1 , 2 , … , N ,$$
wherein, x[k] represents a time-domain vibration signal, g′[k] represents taking a derivative of a window function g[k] as a window function of short-time Fourier transform, M and N respectively represent a line number and a column number of a time-frequency matrix, and constructing the denoising time-frequency matrix Qₓ∈ [symbol] based on the derivative window function short-time Fourier transform:
$${Q}_{x} [ m , n ] = \frac{{P}_{x}^{2} [ m , n ]}{min ( \sqrt{{\sum }_{i = m - δ}^{m} {P}_{x}^{2} [ i , n ]} , \sqrt{{\sum }_{i = m}^{m + δ} {P}_{x}^{2} [ i , n ]} )} , m = 1 , 2 , … , M , n = 1 , 2 , … , N ,$$
wherein, δ is a bandwidth for moving average;
elements in the denoising time-frequency matrix Qₓ are rearranged into vectors Qₓ^{v}∈ [symbol] in columns, and the weighting matrix W∈ [symbol] is obtained by diagonalizing the vectors Qₓ^{v}:
$$W = diag ( \vert {Q}_{x}^{v} \vert ) ,$$
wherein, diag(⋅) represents obtaining a diagonal matrix by diagonalizing the vectors.

14. The method according to claim 11, wherein in the third step (S3), the nonlinear sparse time-frequency enhancement model is:
$$\begin{matrix}\hat{α} = arg {min}_{α} \{ \frac{1}{2} {‖ A α - x ‖}_{2}^{2} + λ {‖ W α ‖}_{1} \} \\ {\hat{N}}_{x} = \hat{α} . / {P}_{x}^{v} ,\end{matrix}$$
wherein, α∈ [symbol] represents a vibration signal time-frequency coefficient, |⋅|₁ represents a norm regularization, A is a regular term parameter, the matrix A∈ [symbol] (MN) represents linear time-frequency transform, Pₓ^{v}∈ [symbol] is a vector result of the derivative window function short-time Fourier transform, which is obtained by rearranging the derivative window function short-time Fourier transform Pₓ∈ [symbol] in columns, \hat{α}∈ [symbol] represents a solving result of a sparse time-frequency representation model, and \hat{N}∈ [symbol] represents a solving result of an overall nonlinear sparse time-frequency analysis model.

15. The method according to claim 11, wherein in the third step (S3), in the nonlinear sparse enhancement algorithm model, a nonlinear weight W is introduced into the iterative shrinkage threshold algorithm, and the nonlinear weight W is set in a gradient descent step:
$$\begin{matrix}{z}^{( i )} = {α}^{( i - 1 )} - μ {A}^{- 1} {W}^{- 1} ( AW {α}^{( i - 1 )} - x ) \\ {α}^{( i )} = soft ( {z}^{( i )} , λμ ) ,\end{matrix}$$
wherein, α⁽ⁱ⁾ represents an iterative optimization result of an i^{th} step, μ represents a step size of gradient descent, the matrix A∈ [symbol] represents linear time-frequency transform, λ represents a regular term parameter, z⁽ⁱ⁾ represents an intermediate process quantity of iterative optimization, a coefficient is divided by the weight W when short-time Fourier transform is performed on a time-domain signal, and then is multiplied by the weight W in an inverse transform process to ensure reversibility of the coefficient, and an operation formula of a soft threshold soft(⋅,⋅) is:
$$soft ( a , τ ) = a \cdot \frac{max \{ \vert a \vert - τ , 0 \}}{max \{ \vert a \vert , τ \}} ,$$
wherein, a represents a variable for performing a soft threshold operation, and τ represents a threshold.

16. The method according to claim 11, wherein in the fourth step (S4), the fast iterative shrinkage threshold algorithm comprises the gradient descent, the soft threshold operation and iterative extrapolation, wherein,
$${z}^{( i )} = {v}^{( i - 1 )} - μ {A}^{- 1} ( {Av}^{( i - 1 )} - x )$$
$${α}^{( i )} = soft ( {z}^{( i )} , λ μ W )$$
$${t}_{i + 1} = \frac{( 1 + \sqrt{1 + 4 {t}_{i}^{2}} )}{2}$$
$${v}^{( i )} = {α}^{( i )} + \frac{( {t}_{i} - 1 )}{{t}_{i + 1}} ( {α}^{( i )} - {α}^{( i - 1 )} ) ,$$
wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, and soft(⋅,⋅) is the operation formula of the soft threshold; and
the k sparse strategy obtains a threshold of the soft threshold operation through a formula T⁽ⁱ⁾=Wq_{[k]}⁽ⁱ⁾, wherein, a superscript i represents an iteration number, q_{[k]}⁽ⁱ⁾ represents a k^{th} largest coefficient in a matrix q⁽ⁱ⁾, the matrix q⁽ⁱ⁾ is obtained by a formula q⁽ⁱ⁾ =W⁻¹z⁽ⁱ⁾, then an iterative result of the i^{th} time is obtained through the soft threshold operation α⁽ⁱ⁾=soft(z⁽ⁱ⁾, T⁽ⁱ⁾), and a soft threshold flow based on the k sparse strategy is completed.

17. The method according to claim 11, wherein in the fourth step (S4), the nonlinear sparse enhancement algorithm model is improved by using the fast iterative shrinkage threshold algorithm and combining the k sparse strategy:
$${z}^{( i )} = {v}^{( i - 1 )} - μ {A}^{- 1} {W}^{- 1} ( {AWv}^{( i - 1 )} - x )$$
$${T}^{( i )} = {z}_{[ k ]}^{( i )}$$
$${α}^{( i )} = soft ( {z}^{( i )} , {T}^{( i )} )$$
$${t}_{i + 1} = \frac{( 1 + \sqrt{1 + 4 {t}_{i}^{2}} )}{2}$$
$${v}^{( i )} = {α}^{( i )} + \frac{( {t}_{i} - 1 )}{{t}_{i + 1}} ( {α}^{( i )} - {α}^{( i - 1 )} ) ,$$
wherein, α⁽ⁱ⁾ represents an iterative optimization result of an i^{th} step, μ represents a step size of the gradient descent, the matrix A∈ [symbol] represents linear time-frequency transform, λ represents a regular term parameter, tᵢ represents an extrapolation parameter, z⁽ⁱ⁾ and v⁽ⁱ⁾ are intermediate process quantities of the algorithm, z_{[k]}⁽ⁱ⁾ represents a k^{th} largest coefficient in z⁽ⁱ⁾, T⁽ⁱ⁾ represents a threshold of i^{th} iterative optimization, and soft(⋅,⋅) is the operation formula of the soft threshold; and
the result obtained by iterative optimization is the nonlinear sparse time-frequency representation result, namely \hat{N}ₓ=\hat{α}.

18. The method according to claim 11, wherein in the fifth step (S5), when the instantaneous dynamic frequency ridge rₓ is extracted based on the nonlinear sparse time-frequency representation result \hat{N}ₓ, a point with a largest amplitude within a target frequency range is selected as a start point (K, rₓ[K]) for ridge search, K represents a time coordinate corresponding to the start point, and rₓ[K] represents a frequency coordinate corresponding to the start point; then ridge points are continuously searched in forward and backward directions based on amplitudes of a time-frequency coefficient, and a formula is:
$${r}_{x} [ n ] = \{ \begin{matrix}arg {max}_{m ∈ ℳ [ n ]} \vert {\hat{N}}_{x} [ m , n ] \vert , & n = 0 , 1 , … , K - 1 \\ arg {max}_{m ∈ ℳ [ n ]} \vert {\hat{N}}_{x} [ m , n ] \vert , & n = K + 1 , K + 2 , … , N - 1\end{matrix} ,$$
wherein, N represents a point number of a time-frequency ridge, and [symbol] [n] is a limited frequency band range relative to a previous moment or subsequent moment when searching for the ridge point at the subsequent moment or previous moment, namely a narrow band range with a frequency at the previous moment or subsequent moment as a center:
$$ℳ [ n ] = \{ \begin{matrix}[ {r}_{x} [ n + 1 ] - {f}_{ω} , {r}_{x} [ n + 1 ] + {f}_{ω} ] , & n = 0 , 1 , … , K - 1 \\ [ {r}_{x} [ n - 1 ] - {f}_{ω} , {r}_{x} [ n - 1 ] + {f}_{ω} ] , & n = K + 1 , K + 2 , … , N - 1\end{matrix} ,$$
wherein, f_{ω} is a half bandwidth; and
as for the extracted instantaneous dynamic frequency ridge rₓ, a spectrum feature \tilde{r}ₓ of the ridge is obtained through de-averaging and Fourier transform.

19. The method according to claim 18, wherein in the sixth step (S6), a peak value rₚₚᵥ of a time-frequency ridge peak, total energy Eₜ of a ridge spectrum of 0-500 Hz and a proportion Eᵣ of a low-voltage rotating frequency in the spectrum are calculated based on the instantaneous dynamic frequency ridge rₓ and the spectrum feature \tilde{r}ₓ thereof, so as to judge whether an intermediate bearing fault exists, wherein,
the peak value rₚₚᵥ of the time-frequency ridge peak:
$${r}_{p p v} = max ( {r}_{x} ) - min ( {r}_{x} ) ,$$
the total energy Eₜ of the ridge spectrum of 0-500 Hz:
$${E}_{t} = {\sum }_{f = 0}^{500} {\vert {\tilde{r}}_{x} [ f ] \vert}^{2} Δ f ,$$
and
the proportion Eᵣ of the low-voltage rotating frequency in the spectrum of the time-frequency ridge:
$${E}_{r} = \frac{{\vert {\tilde{r}}_{x} [ {f}_{L} ] \vert}^{2} Δ f}{{\sum }_{f = 0}^{500} {\vert {\tilde{r}}_{x} [ f ] \vert}^{2} Δ f} ,$$
wherein, f_{L} represents the low-voltage rotating frequency, and Δf represents a frequency resolution.

20. The method according to claim 19, wherein in the sixth step (S6), based on a distribution histogram of indicators of the intermediate bearing in different states, thresholds of all indicators are determined through statistical analysis, a relevant state indicator is represented by c, and a threshold thereof is determined as follows:
calculating state indicators c of each data and drawing a trend, corresponding to fault free and faulty intermediate bearings; and
fitting the distribution of two state indicators through two Gaussian function curves to obtain probability density functions fₙ(c) and f_{w} of the distribution of fault free and faulty state indicators, wherein the adopted Gaussian function is:
$${f}_{n} ( c ) = \frac{1}{{σ}_{n} \sqrt{2 π}} {e}^{- \frac{{( c - {μ}_{n} )}^{2}}{2 {σ}_{n}^{2}}} , f \frac{1}{{σ}_{w} \sqrt{2 π}} {e}_{w}^{- \frac{{( c - {μ}_{w} )}^{2}}{2 {σ}_{w}^{2}}} ,$$
wherein, σₙ and ow respectively represent a standard deviation of fault free and faulty data, and μₙ and μ_{w} respectively represent mean values of the fault free and faulty data,
an intersection point of the two probability density functions is selected as a threshold T_{c} of the state indicators, namely:
$${T}_{c} = c \qquad s . t . {f}_{n} ( c ) = {f}_{w} ,$$
when the following conditions are met simultaneously, it is considered that the intermediate bearing has a fault:
$${r}_{p p v} \geq {T}_{r} , {E}_{t} \geq {T}_{E 1} , and {E}_{r} \geq {T}_{E 2} ,$$
wherein, Tᵣ, T_{E1} and T_{E2} respectively represent the thresholds of the three state indicators of the peak value of the time-frequency ridge peak, the total energy of the ridge spectrum of 0-500 Hz and the proportion of the low-voltage rotating frequency in the spectrum of the time-frequency ridge.
